(19) United States
(12) Patent Application Publication
(10) Pub. No.: US 2026/0350391 A1
(43) Pub. Date: Nov. 5, 2026

(54) TASK EXECUTION METHOD, ELECTRONIC DEVICE, AND STORAGE MEDIUM

(71) Applicant: Beijing Baidu Netcom Science Technology Co., Ltd., Beijing (CN)

(72) Inventors: Kai LIU, Beijing (CN); Baoshan YANG, Beijing (CN); Yesong WANG, Beijing (CN)

(21) Appl. No.: 19/713,405

(22) Filed: Jun. 18, 2026

(30) Foreign Application Priority Data
Mar. 20, 2026 (CN) 202610353610.2

(51) Int. Cl. G06N 3/08

(52) U.S. Cl. CPC G06N 3/08

(57) ABSTRACT

A task execution method, relating to fields of artificial intelligence technology, large models, distributed computing, and deep learning, includes executing, using at least one hardware device, an inference task based on a large model according to a sequence of input data units to obtain a sequence of output data units, first probability information and second probability information for the sequence of input data units, the first probability information including at least one first probability value corresponding one-to-one to at least one first data unit in the sequence of output data units, the second probability information including at least one second probability value corresponding one-to-one to at least one second data unit in a sequence of label data units of the sequence of input data units; and determining a difficulty evaluation result for the sequence of input data units according to the first and second probability information.

This application claims the benefit of priority to Chinese Patent Application No. 202610353610.2, filed on Mar. 20, 2026. The entire contents of this application are hereby incorporated herein by reference.

### TECHNICAL FIELD

The present disclosure relates to a field of artificial intelligence technology, and in particular to generative large models, large language models (LLM), distributed computing, and deep learning technology, applicable in text-to-image generation and question-answering scenarios. More specifically, the present disclosure provides a task execution method, an electronic device, and a storage medium.

### BACKGROUND

In the current fine-tuning engineering of large language models, the demand for data quality is higher than that for data quantity. The quality of Supervised Fine-Tuning (SFT) data is difficult to quantify objectively and often relies on manual annotation or the invocation of strong models for evaluation to determine data difficulty. However, such difficulty deviates to some extent from the actual learning cost of the model.

### SUMMARY

The present disclosure provides a task execution method, an electronic device, and a storage medium.

According to an aspect of the present disclosure, a task execution method is provided. The method comprises: executing, using at least one hardware device, an inference task based on a large model according to a sequence of input data units, so as to obtain a sequence of output data units for the sequence of input data units, first probability information for the sequence of input data units, and second probability information for the sequence of input data units, where the first probability information includes at least one first probability value, the at least one first probability value corresponds one-to-one to at least one first data unit in the sequence of output data units, the second probability information includes at least one second probability value, and the at least one second probability value corresponds one-to-one to at least one second data unit in a sequence of label data units of the sequence of input data units; and determining a difficulty evaluation result for the sequence of input data units according to the first probability information and the second probability information.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided in the present disclosure.

According to another aspect of the present disclosure, a non-transitory computer-readable storage medium having computer instructions therein is provided, where the computer instructions are used to cause a computer to implement the method provided in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a flow chart of a task execution method according to an embodiment of the present disclosure;

FIG. 2A shows a schematic diagram of executing an inference task based on a large model according to an embodiment of the present disclosure;

FIG. 2B shows a schematic diagram of executing an inference task based on a large model according to another embodiment of the present disclosure;

FIG. 2C shows a schematic diagram of executing an inference task based on a large model according to another embodiment of the present disclosure;

FIG. 2D shows a schematic diagram of executing an inference task based on a large model according to another embodiment of the present disclosure;

FIG. 3 shows a block diagram of a task execution apparatus according to an embodiment of the present disclosure; and

FIG. 4 shows a block diagram of an electronic device for implementing a task execution method according to an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skill in the art should realize that various changes and modifications may be made to embodiments described herein without departing from the scope and spirit of the present disclosure. Likewise, for clarity and conciseness, descriptions of well-known functions and structures are omitted in the following description.

In the related art, definitions of SFT data difficulty may be categorized as follows:

First, defining difficulty based on human cognitive logic. Levels are classified by defining task types (e.g., mathematical proof are more difficult than daily conversation), number of logical steps, rarity of knowledge points, etc.

Second, defining difficulty based on simple statistical features. Existing technologies often use text length, vocabulary richness, or syntactic complexity as proxy indicators of difficulty.

Third, evaluating difficulty using a judge model. A higher-order strong model is used as a judge to assign scores, for example, using prompts to let the model judge instruction difficulty and perform evolution, or to let the model score sample quality and difficulty.

Fourth, defining difficulty based on information-theoretic statistical methods. For example, relevant statistical indicators include Perplexity (PPL), influence functions, etc. However, a high PPL may also represent other meanings. Influence functions calculate, through mathematical approximation, the amount of change in model parameters after removing a certain training sample. Samples with large influence values contribute the most to model shaping capability and generally correspond to the core of difficulty from the model's perspective. C-Score (Consistency Score) is based on the model's prediction accuracy for samples under different training durations. If a model takes a long time (a plurality of training steps) to learn a certain sample, then the sample has a lower C-Score and higher data difficulty.

The above methods all have their applicable domains and advantages, but there are some issues regarding objective difficulty evaluation.

Difficulty evaluation methods based on human cognitive logic have significant defects, such as subjectivity and inconsistency. These methods heavily rely on manual annotation or preset rules (e.g., task categories, knowledge point hierarchies). Differences in individual annotators'cognition make it difficult to unify difficulty grading standards, failing to form an objective and universal evaluation system. Difficulty perceived by humans is usually based on logical depth, whereas difficulty perceived by models stems from the data distribution in parameter space. Cross-domain transferability is poor; difficulty logic established for specific disciplines (e.g., law or medicine) may not be automatically transferred to other fields, lacking generalization.

Difficulty evaluation methods based on simple statistical features use various indicators. Although these indicators are objective, they are static features characterized by shallowness of feature dimensions. Indicators such as text length, word frequency, or syntactic structure only reflect superficial characteristics of the data and may not reach the deep semantic logic and information density of the corpus. There is no significant linear correlation between the physical length of text and the model's actual learning cost. Simply defining high difficulty based only on long texts may cause a large amount of redundant data with low information volume to be mislabeled, thereby obscuring truly challenging high-difficulty samples.

Judge models also have certain limitations. The judge model requires human alignment in the fine-tuning stage, resulting in its judgment criteria still carrying strong human consensus bias. Additionally, invoking a large model to evaluate tens of millions or even hundreds of millions of SFT corpora one by one incurs enormous inference computational overhead and time costs, making it infeasible in industrial-scale pre-processing scenarios. Moreover, the scores given by judge models lack interpretability and may not provide developers with effective references regarding the underlying distribution characteristics of the data.

Although PPL difficulty evaluation may reflect the model's predictive capability for data, high PPL is ambiguous: it may represent either that the data contains high-value new knowledge (difficulty not yet mastered by the model) or that the data itself contains significant grammatical noise, garbled text, or low-quality content. Without introducing an additional discriminator, the PPL difficulty evaluation method struggles to decouple effective difficulty from random noise. Although the influence function method may mathematically approximate the contribution of samples to parameter changes, its core involves the inverse operation of the Hessian matrix. When dealing with large language models with hundreds of billions of parameters, the computational complexity of this method grows exponentially, making it extremely difficult to implement in practical fine-tuning engineering. C-Score is heavily dependent on a plurality of checkpoint comparisons of the model under different training durations; to determine data difficulty, at least one complete simulation training must be performed first. This logic of training first and grading later is not only extremely time-consuming but also tends to yield difficulty scores that are significantly affected by initial weights, resulting in a lack of generalizability of the results across models of different architectures.

The above evaluation solutions lack universal and objective evaluation standards, have considerable subjectivity, and are difficult to form universal objective standards across different domains and datasets of different scales. Furthermore, the above methods may not perform important data mining. The logical difficulty perceived by humans is not linearly correlated with the fitting difficulty of large language models in parameter optimization. The above methods struggle to identify data that is simple for humans but crucial for model capability evolution, leading to inefficient training.

The objective solution for general difficulty evaluation in the present disclosure shifts the perspective to the model itself. By monitoring the model's statistical performance when processing specific samples, the cognitive damping of the data in the model's representation space is derived inversely. The difficulty definition from the model's perspective aims to capture the information increment in the data that may truly drive the effective evolution of model parameters, thereby providing scientific support for achieving more efficient curriculum learning and precise data pruning. This available difficulty evaluation strategy of the present disclosure may be specifically applied in the following areas:

First, data difficulty labeling. When constructing large-scale SFT datasets, the difficulty evaluation strategy of the present disclosure is used as a labeler to add difficulty indicators to training data, increasing the data profiling dimensions, performing data proportioning, and applying it to model training.

Second, learning strategy construction. Based on the difficulty scores from the model's perspective, training data is arranged from easy to hard (or in a specific order). By injecting corpora of different difficulties at different stages of model training, model convergence speed and generalization capability are improved.

Third, model capability fine-tuning. High-difficulty data is identified from the model's perspective, and training is strengthened accordingly to resolve the model's understanding bottlenecks in specific professional tasks, thereby enhancing model capabilities.

To achieve objective difficulty evaluation of model capabilities, the present disclosure provides a task execution method, which is described below.

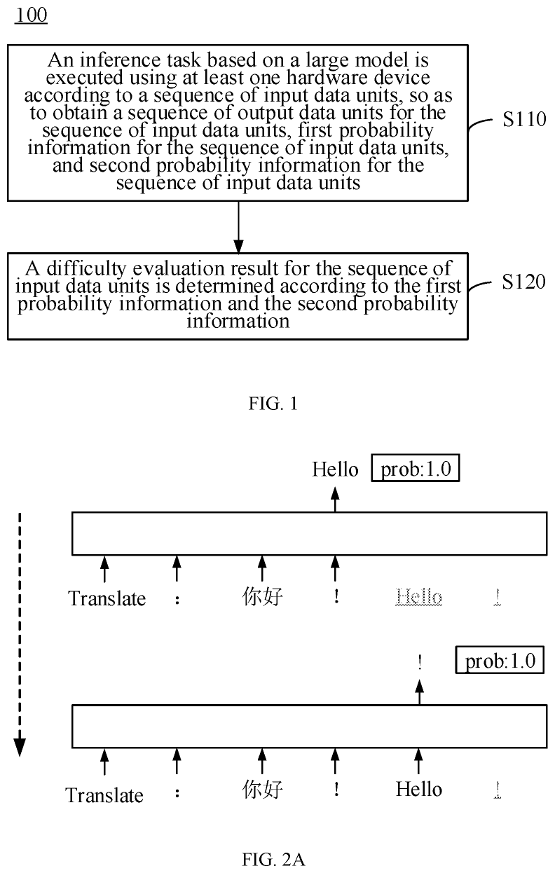

FIG. 1 shows a flow chart of a task execution method according to an embodiment of the present disclosure.

As shown in FIG. 1, a method 100 may include operation S110 to operation S120.

In operation S110, an inference task based on a large model is executed using at least one hardware device according to a sequence of input data units, so as to obtain a sequence of output data units for the sequence of input data units, first probability information for the sequence of input data units, and second probability information for the sequence of input data units.

The hardware device may be, for example, a server, terminal device, or the like on which a large model is deployed. The large model deployed on the hardware device may be, for example, a preheating model obtained by performing a small amount of data training and preheating on a base model (a model that has not been trained on training data). The sequence of input data units may be a token sequence for input to the large model. The inference task of the large model may be to predict subsequent content based on the sequence of input data units. The sequence of output data units may be an output token sequence inferred by the large model based on the sequence of input data units.

The first probability information includes at least one first probability value, and the at least one first probability value corresponds one-to-one to at least one first data unit in the sequence of output data units. In the decoding process of the large model, to decode one output token, one or more candidate tokens may be determined, and the probability of each candidate token may be determined. Among the one or more candidate tokens, the candidate token with the highest probability may serve as the model's output token. The first probability information refers to probability information related to the output token. The first data unit may refer to the output token corresponding to the first probability value.

The second probability information includes at least one second probability value, and the at least one second probability value corresponds one-to-one to at least one second data unit in a sequence of label data units of the sequence of input data units. The second data unit may refer to an expected token in the sequence of output data units. The input data may have a label. Converting the label into a token sequence yields a sequence of label data units of the sequence of input data units. The sequence of label data units may include one or more expected tokens. If the aforementioned one or more candidate tokens include a candidate token identical to the expected token, the probability of that candidate token may serve as the probability of the expected token, i.e., the second probability value corresponding to the second data unit. It will be appreciated that if the one or more candidate tokens do not include the expected token, the probability of the expected token may be zero. Furthermore, the output token and the expected token may also be the same.

In operation S120, a difficulty evaluation result for the sequence of input data units is determined according to the first probability information and the second probability information.

According to the first probability information and the second probability information, it may be determined whether the inference result of the large model for the sequence of input data units is close to or consistent with an expected result. If the first probability information and the second probability information indicate that the inference result of the large model is relatively close to the expected result, the difficulty evaluation result for the sequence of input data units may be determined as low-difficulty data; if the first probability information and the second probability information indicate that the inference result of the large model is inconsistent with the expected result, the difficulty evaluation result for the sequence of input data units may be determined as high-difficulty data.

According to embodiments of the present disclosure, the model is preheated with a very small amount of representative data, and then, the difficulty distribution of the data may be acquired through a single inference. This reduces the complexity of difficulty evaluation from the training level to the inference level, allowing data difficulty to be determined at the inference stage without needing to enter the training stage to obtain the loss and then determine difficulty. The hardware resource overhead required for difficulty evaluation (e.g., computational resource overhead and storage resource overhead) is also reduced from the training level to the inference level, shortening the data preprocessing cycle and significantly reducing hardware resource overhead.

It will be appreciated that the method of the present disclosure has been described above, and the probability information of the present disclosure will be described below.

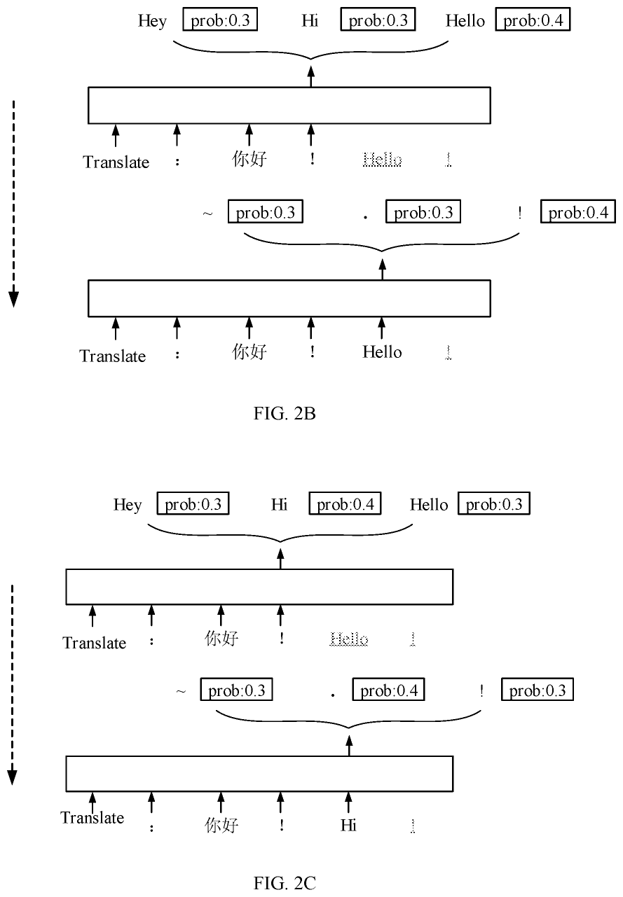

FIG. 2A to FIG. 2D show schematic diagrams of executing an inference task based on a large model according to different embodiments of the present disclosure.

The input text may be “Translate: [symbol] !” (“ [symbol] ” are Chinese characters, English translation of “ [symbol] ” is hello). The label of the input text may be “Hello!”.

As shown in FIG. 2A, in the process of decoding one token, the input text input to the large model is processed by a tokenizer to obtain an input token sequence. The input token sequence may include four tokens, namely a token for “Translate”, a token for “:”, a token for “ [symbol] ”, and a token for “!”. Based on the input token sequence, the large model performs inference and outputs one token, which may be converted to “Hello”, as shown in FIG. 2A, the probability of that token is 1.0.

After decoding the token “Hello”, the large model may concatenate the token “Hello” with the input token sequence to obtain a concatenated sequence to continue decoding. As shown in FIG. 2A, the large model may decode the token following the token “Hello” as the token “!”, and the probability of the token “!” is 1.0.

The output text of the large model shown in FIG. 2A is consistent with the label of the input text. The model shown in FIG. 2A fully predicts the data units in the sequence of output data units, and the current input text is relatively easy for the model to understand, requiring no training. It will be appreciated that the difficulty of the same input text may also differ for different models, which will be described hereinafter.

As shown in FIG. 2B, based on the input token sequence determined from the input text “Translate: [symbol] !”, the token output by the large model may be a token determined from a plurality of candidate tokens. The plurality of candidate tokens may be a token for “Hello”, a token for “Hi”, and a token for “Hey”. The probability of the large model outputting the token “Hi” is 0.3, the probability of the large model outputting the token “Hey” is 0.3, and the probability of the large model outputting the token “Hello” is 0.4. Based on the probabilities, the token “Hello” with the highest probability may be selected, from the plurality of candidate tokens, as the output token.

After decoding the token “Hello”, the large model may concatenate the token “Hello” with the input token sequence to obtain a concatenated sequence to continue decoding. According to the decoding of the large model, there may be a plurality of candidate tokens after the token “Hello”, namely a token “!”, a token “~”, and a token “.”. The probability of the large model outputting the token “~” is 0.3, the probability of the large model outputting the token “.” is 0.3, and the probability of the large model outputting the token “!” is 0.4. Based on the probabilities, the token “!” with the highest probability may be selected, from the plurality of candidate tokens, as the output token.

On the basis of ensuring model output diversity, the token output by the model shown in FIG. 2B is consistent with the expected token and has the highest probability. Therefore, it may be considered that the sequence of input data units is relatively simple for the model. Further description will be provided with another embodiment.

As shown in FIG. 2C, based on the input token sequence determined from the input text “Translate: [symbol] !”, the token output by the large model may be a token determined from a plurality of candidate tokens. The plurality of candidate tokens may be a token for “Hello”, a token for “Hi”, and a token for “Hey”. The probability of the large model outputting the token “Hi” is 0.4, the probability of the large model outputting the token “Hey” is 0.3, and the probability of the large model outputting the token “Hello” is 0.3. Based on the probabilities, the token “Hi” with the highest probability may be selected, from the plurality of candidate tokens, as the output token.

After decoding the token “Hi”, the large model may concatenate the token “Hi” with the input token sequence to obtain a concatenated sequence to continue decoding. According to the decoding of the large model, there may be a plurality of candidate tokens after the token “Hi”, namely a token “!”, a token “~”, and a token “.”. The probability of the large model outputting the token “~” is 0.3, the probability of the large model outputting the token “.” is 0.4, and the probability of the large model outputting the token “!” is 0.3. Based on the probabilities, the token “.” with the highest probability may be selected, from the plurality of candidate tokens, as the output token.

When outputting tokens, the model shown in FIG. 2C generates a plurality of candidate tokens among which there is a token with a higher probability than the expected token, indicating that the model has multiple choices for the output tokens, and the sequence of output data units is just one of the options. That is, the sequence of input data units is relatively difficult for the model.

As shown in FIG. 2D, based on the input token sequence determined from the input text “Translate: [symbol] !”, the plurality of candidate tokens generated by the large model may be a token for “Hello” and a token for “Hi”. The probability of the large model outputting the token “Hi” is 0.9, and the probability of the large model outputting the token “Hello” is 0.1. Based on the probabilities, the token “Hi” with the highest probability may be selected, from the plurality of candidate tokens, as the output token.

After decoding the token “Hi”, the large model may concatenate the token “Hi” with the input token sequence to obtain a concatenated sequence to continue decoding. According to the decoding of the large model, there may be a plurality of candidate tokens after the token “Hi”, namely a token “!” and a token “.”. The probability of the large model outputting the token “.” is 0.9, and the probability of the large model outputting the token “!” is 0.1. Based on the probabilities, the token “.” with the highest probability is selected, from the plurality of candidate tokens, as the output token.

For the model shown in FIG. 2D, the probability of the output token differs significantly from the probability of the expected token, indicating that the model finds it difficult to understand the currently input sequence of input data units, and the data difficulty is high.

It will be appreciated that different cases of probability information have been described above, and the difficulty evaluation result of the present disclosure will be described below.

According to embodiments of the present disclosure, the first probability information includes a plurality of first probability values, and the second probability information includes plurality of second probability values. The first probability value may refer to the probability value corresponding to each output token in the sequence of output data units. The second probability value may refer to the probability value corresponding to each expected token.

The determining a difficulty evaluation result for the sequence of input data units according to the first probability information and the second probability information includes: multiplying the plurality of first probability values to obtain a first product result as first fusion information. The first fusion information refers to the cumulative probability of the optimal token deemed by the current model in the given context, which may be obtained by the following equation (1):

P_{max_merge}=πΠᵢⁿPₘₐₓ (1)

P_{max_merge} is the first fusion information, n is the number of data units in the sequence of output data units, and Pmax is the first probability value. Taking FIG. 2D as an example, P_{max_merge}=( 9/10)×( 9/10), i.e., the probability value of the token “Hi” multiplied by the probability value of the token “.” yields the first fusion information for the sequence of input data units.

The plurality of second probability values are multiplied to obtain a second product result as second fusion information. The second fusion information refers to the generation probability of the expected token on the current model, which may be obtained by the following equation (2):

P_{golden_merge}=Πᵢⁿ P_{golden} (2)

P_{golden_merge} is the second fusion information, n is the number of data units in the sequence of label data units, and P_{golden} is the first probability value. Taking FIG. 2D as an example, P_{golden_merge}=( 1/10)×( 1/10), i.e., the probability value of “Hello” multiplied by the probability value of “!” yields the second fusion information for the sequence of input data units.

In embodiments of the present disclosure, to ensure the output diversity of the model, the requirement for the model's training target sequence is that the output probability of the token reaches a relatively optimal state (probability of the expected token>probability of other tokens), rather than an absolute optimum (i.e., the probability of the expected token being 1). The prediction difficulty defined by the model refers to the relative distance from the probability of the model predicting the expected token to the probability of the model predicting the optimal token.

A difficulty evaluation result for the sequence of input data units is determined according to the first fusion information and the second fusion information.

The first fusion information may represent the probability of the model predicting the optimal token, and the second fusion information may represent the probability of the model predicting the expected token. The relative distance from the probability of the model predicting the expected token to the probability of the model predicting the optimal token may be determined according to the first fusion information and the second fusion information, thereby defining the prediction difficulty of the sequence of input data units.

According to embodiments of the present disclosure, the determining the difficulty evaluation result for the sequence of input data units according to the first fusion information and the second fusion information includes: dividing the second fusion information by the first fusion information to obtain a division operation result; raising the division operation result to a power of a reciprocal of an evaluation parameter to obtain a root result, where the evaluation parameter is determined according to at least one of a first quantity or a second quantity, the first quantity being the number of first data units in the sequence of output data units, the second quantity being the number of second data units in the sequence of label data units of the sequence of input data units; and subtracting the root result from a preset value to obtain the difficulty evaluation result.

The difficulty evaluation result may be obtained by the following equation (3):

D=1−(P_{golden_merge}/P_{max_merge})^{1/n} (3)

The division operation result is P_{golden_merge}/P_{max_merge}, and the evaluation parameter n is determined according to at least one of the first quantity (the number of first data units in the sequence of output data units) and the second quantity (the number of second data units in the sequence of label data units of the sequence of input data units).

If the first quantity equals the second quantity, the evaluation parameter is determined by either the first quantity or the second quantity; if the first quantity does not equal the second quantity, either the larger one or the smaller one of the first quantity and the second quantity may be selected as the evaluation parameter. The preset value may be, for example, 1. The difficulty evaluation result may also refer to the geometric mean of the probability differences between the model's output tokens and the expected tokens.

According to embodiments of the present disclosure, the difficulty evaluation result indicates a difficulty of executing the inference task based on the large model according to the sequence of input data units, and may also indicate an accuracy of executing the inference task according to the sequence of input data units.

When the optimal token output by the model is the same as the expected token, the difficulty evaluation result D=0, indicating that it is less difficult for the model to understand the sequence of input data units; when the probability difference between the optimal token output by the model and the expected token is large, the difficulty evaluation result D≈1, indicating that it is more difficult for the model to understand the sequence of input data units.

According to embodiments of the present disclosure, the difficulty evaluation result is derived from the model's predictive feedback on the expected token, enabling the mining of samples that are evaluated as simple but are difficult for the model to fit. This decouples the human prior evaluation system, aligns more closely with the essential laws of model fine-tuning, and improves the efficiency of model fine-tuning. Moreover, the token output by the model is related to the hardware resources of the hardware device, which affect the inference capability of the large model. Based on the probability difference between the output token and the expected token, input data that is more difficult for the large model deployed on at least one hardware device under current hardware resource conditions may be effectively mined, allowing for targeted model adjustment or increased hardware resources guided by the difficulty evaluation result.

It will be appreciated that the method of determining the difficulty evaluation result of the present disclosure has been described above, and the method of the present disclosure will be further described below.

According to embodiments of the present disclosure, the executing, using at least one hardware device, an inference task based on a large model according to a sequence of input data units includes: executing, using the at least one hardware device, a plurality of inference tasks based on the large model according to a plurality of sequences of input data units, so as to obtain a plurality of sequences of output data units respectively for the plurality of sequences of input data units, a plurality of first probability information respectively for the plurality of sequences of input data units, and a plurality of second probability information respectively for the plurality of sequences of input data units.

After using a small amount of data to train and preheat the base model, the model possesses certain general capabilities. And then, the preheating model may be used to perform inference tasks in a given context on a plurality of training data to be evaluated. For a plurality of inference tasks corresponding to a plurality of sequences of input data units, the large model may provide a sequence of output data units for each sequence of input data units, first probability information for each sequence of input data units, and second probability information for each sequence of input data units. A difficulty evaluation result for each of the plurality of training data may be determined according to the first probability information and the second probability information.

According to embodiments of the present disclosure, at least one sequence of input data units corresponding one-to-one to at least one target evaluation result is determined as at least one sequence of training data units, and the target evaluation result is a difficulty evaluation result that is greater than or equal to a preset difficulty threshold among the plurality of difficulty evaluation results; at least one first training task for the large model is executed using the at least one hardware device according to the at least one sequence of training data units, so as to reduce hardware resource overhead required for executing a plurality of second training tasks for the large model according to the plurality of sequences of input data units.

A difficulty evaluation result greater than or equal to the preset difficulty threshold may indicate a high-difficulty sequence of data units that is relatively difficult for the model to understand, whereas a difficulty evaluation result less than the preset difficulty threshold may indicate that the sequence of input data units represents knowledge already mastered by the model. The first training task refers to using the sequences of input data units whose difficulty evaluation results are greater than or equal to the preset difficulty threshold as the sequences of training data units, and inputting the sequences of training data units into the large model for training, which may prevent the model from repeatedly learning already mastered knowledge and focus computational power on high-difficulty data that the model may not understand. The second training task may refer to using all sequences of input data units as the sequences of training data units to train the large model. Training based on full data incurs high resource overhead, and training the model with low-difficulty data makes it difficult to improve model performance and also leads to underutilization of hardware resources. By using high-difficulty data to execute the first training task of the large model, the model's understanding and inferring capabilities may be enhanced with lower hardware resource overhead, improving hardware resource utilization.

According to embodiments of the present disclosure, the first training task includes a forward computation subtask and a backward computation subtask, and the executing, using the at least one hardware device, at least one first training task for the large model according to the at least one sequence of training data units includes: executing, using the at least one hardware device, the forward computation subtask for the large model according to the sequence of training data units, so as to obtain a sequence of data units to be verified for training data; and executing, using the at least one hardware device, the backward computation subtask for the large model according to a difference between the sequence of data units to be verified and a sequence of label data units of the sequence of training data units, so as to adjust a parameter of the large model.

The forward computation subtask refers to the task in which the large model performs inference and prediction according the sequence of training data units to obtain a sequence of data units to be verified. The backward computation subtask may refer to calculating a loss based on the difference between the sequence of data units to be verified and the sequence of label data units of the sequence of training data units, and determining gradient values of parameters based on the loss, thereby fine-tuning the parameters of the large model to continuously reduce the loss.

According to embodiments of the present disclosure, through the selection logic of objective difficulty evaluation, the model's weaknesses are accurately identified, boundary samples that the model finds difficult to understand are selected, and the model is trained on difficult data to enhance the understanding and inferring capabilities of the model.

According to embodiments of the present disclosure, the sequence of input data units is determined according to at least one of an input text, an input image, an input audio, or an input video, and the sequence of output data units is converted into at least one of an output text, an output image, an output audio, or an output video.

In embodiments of the present disclosure, the input data may be single-modal or multi-modal data in various forms such as a text, an image, an audio, and a video.

According to embodiments of the present disclosure, the sequence of input data units includes a sequence of input tokens determined according to the input text, and the sequence of output data units is a sequence of output tokens, and the executing, using at least one hardware device, an inference task based on a large model according to a sequence of input data units includes: tokenizing the input text to obtain the sequence of input tokens; executing, using at least one hardware device, the inference task based on the large model according to the sequence of input tokens, so as to obtain the sequence of output tokens for the sequence of input tokens; and obtaining the output text according to the sequence of output tokens.

Tokenizing may refer to breaking down continuous input text into discrete, meaningful tokens. A plurality of tokens obtained from the input text conversion may form an input token sequence according to the contextual order of the input text. The large model performs inference on the input token sequence to obtain a corresponding output token sequence, and concatenating a plurality of tokens of the output token sequence yields the output text.

According to embodiments of the present disclosure, the objective difficulty evaluation strategy of the present disclosure improves difficulty evaluation efficiency compared to related art and overcomes the excessive dependence on computational resources as seen in existing dynamics-based methods such as C-Score. The difficulty evaluation result provided by the present disclosure is directly derived from the model's predictive feedback on the expected token, enabling the mining of samples that humans consider simple but the model finds difficult to fit, and further enabling the mining of truly difficult data under the constraints of objective laws such as limited hardware resources. This decouples the human prior evaluation system, and aligns more closely with the essential laws of model fine-tuning.

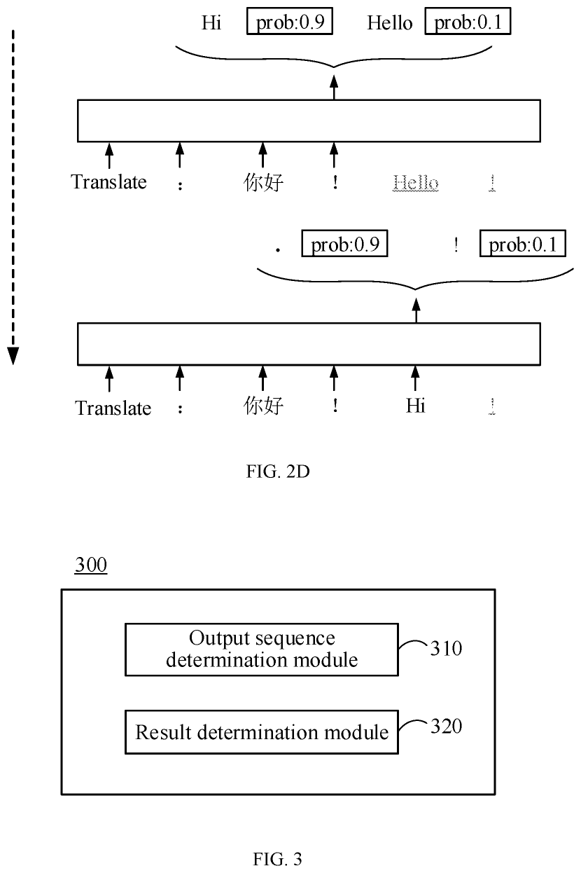

FIG. 3 shows a block diagram of a task execution apparatus according to an embodiment of the present disclosure.

As shown in FIG. 3, a task execution apparatus 300 of the embodiment includes an output sequence determination module 310 and a result determination module 320.

The output sequence determination module 310 is used to execute, using at least one hardware device, an inference task based on a large model according to a sequence of input data units, so as to obtain a sequence of output data units for the sequence of input data units, first probability information for the sequence of input data units, and second probability information for the sequence of input data units, where the first probability information includes at least one first probability value, the at least one first probability value corresponds one-to-one to at least one first data unit in the sequence of output data units, the second probability information includes at least one second probability value, and the at least one second probability value corresponds one-to-one to at least one second data unit in a sequence of label data units of the sequence of input data units.

The result determination module 320 is used to determine a difficulty evaluation result for the sequence of input data units according to the first probability information and the second probability information.

According to embodiments of the present disclosure, the first probability information includes a plurality of first probability values, and the second probability information includes plurality of second probability values. Based on the first probability information and the second probability information, the result determination module 320 includes a first fusion sub-module, a second fusion sub-module, and a result determination sub-module. The first fusion sub-module is used to multiply the plurality of first probability values to obtain a first product result as first fusion information; the second fusion sub-module is used to multiply the plurality of second probability values to obtain a second product result as second fusion information; and the result determination sub-module is used to determine the difficulty evaluation result for the sequence of input data units according to the first fusion information and the second fusion information.

According to embodiments of the present disclosure, the result determination sub-module includes a division unit, a root extraction unit, and a result determination unit. The division unit is used to divide the second fusion information by the first fusion information to obtain a division operation result; the root extraction unit is used to raise the division operation result to a power of a reciprocal of an evaluation parameter to obtain a root result, where the evaluation parameter is determined according to at least one of a first quantity or a second quantity, the first quantity being a number of first data units in the sequence of output data units, the second quantity being a number of second data units in the sequence of label data units of the sequence of input data units; and the result determination unit is used to subtract the root result from a preset value to obtain the difficulty evaluation result.

According to embodiments of the present disclosure, the output sequence determination module 310 includes an output sequence determination sub-module used to execute, using the at least one hardware device, a plurality of inference tasks based on the large model according to a plurality of sequences of input data units, so as to obtain a plurality of sequences of output data units respectively for the plurality of sequences of input data units, a plurality of first probability information respectively for the plurality of sequences of input data units, and a plurality of second probability information respectively for the plurality of sequences of input data units.

According to embodiments of the present disclosure, the task execution apparatus 300 further includes a sequence determination module and a first training module. The sequence determination module is used to determine at least one sequence of input data units corresponding one-to-one to at least one target evaluation result as at least one sequence of training data units, where the target evaluation result is a difficulty evaluation result being greater than or equal to a preset difficulty threshold among a plurality of difficulty evaluation results; and the first training module is used to execute, using the at least one hardware device, at least one first training task for the large model according to the at least one sequence of training data units, so as to reduce hardware resource overhead required for executing a plurality of second training tasks for the large model according to the plurality of sequences of input data units.

According to embodiments of the present disclosure, the first training task includes a forward computation subtask and a backward computation subtask. The first training module includes a forward computation sub-module and a backward computation sub-module. The forward computation sub-module is used to execute, using the at least one hardware device, the forward computation subtask for the large model according to the sequence of training data units, so as to obtain a sequence of data units to be verified for training data; and the backward computation sub-module is used to execute, using the at least one hardware device, the backward computation subtask for the large model according to a difference between the sequence of data units to be verified and a sequence of label data units of the sequence of training data units, so as to adjust a parameter of the large model.

According to embodiments of the present disclosure, the difficulty evaluation result indicates a difficulty of executing the inference task based on the large model according to the sequence of input data units.

According to embodiments of the present disclosure, the sequence of input data units is determined according to at least one of an input text, an input image, an input audio, or an input video, and the sequence of output data units is converted into at least one of an output text, an output image, an output audio, or an output video.

According to embodiments of the present disclosure, the sequence of input data units includes a sequence of input tokens determined according to the input text, and the sequence of output data units is a sequence of output tokens.

The output sequence determination module 310 includes a conversion sub-module, an inference sub-module, and an output sub-module. The conversion sub-module is used to tokenize the input text to obtain the sequence of input tokens; the inference sub-module is used to execute, using at least one hardware device, the inference task based on the large model according to the sequence of input tokens, so as to obtain the sequence of output tokens for the sequence of input tokens; and the output sub-module is used to obtain the output text according to the sequence of output tokens.

In the technical solution of the present disclosure, the collection, storage, use, processing, transmission, provision, disclosure, and other processing of user personal information involved comply with relevant laws and regulations and do not violate public order and good customs.

According to embodiments of the present disclosure, the present disclosure further provides an electronic device, a readable storage medium, and a computer program product.

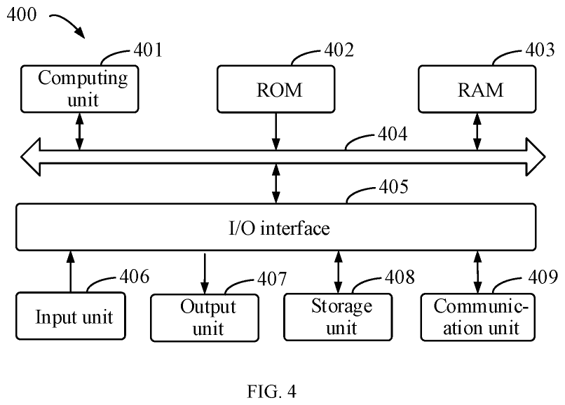

FIG. 4 shows a schematic block diagram of an example electronic device 400 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 4, the device 400 includes a computing unit 401 which may perform various appropriate actions and processes according to a computer program stored in a read only memory (ROM) 402 or a computer program loaded from a storage unit 808 into a random access memory (RAM) 403. In the RAM 403, various programs and data necessary for an operation of the device 400 may also be stored. The computing unit 401, the ROM 402 and the RAM 403 are connected to each other through a bus 404. An input/output (I/O) interface 405 is also connected to the bus 404.

A plurality of components in the device 400 are connected to the I/O interface 405, including: an input unit 406, such as a keyboard, or a mouse; an output unit 407, such as displays or speakers of various types; a storage unit 408, such as a disk, or an optical disc; and a communication unit 409, such as a network card, a modem, or a wireless communication transceiver. The communication unit 409 allows the device 400 to exchange information/data with other devices through a computer network such as Internet and/or various telecommunication networks.

The computing unit 401 may be various general-purpose and/or dedicated processing assemblies having processing and computing capabilities. Some examples of the computing units 401 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 401 executes various methods and processes described above, such as the task execution method. For example, in some embodiments, the task execution method may be implemented as a computer software program which is tangibly embodied in a machine-readable medium, such as the storage unit 408. In some embodiments, the computer program may be partially or entirely loaded and/or installed in the device 400 via the ROM 402 and/or the communication unit 409. The computer program, when loaded in the RAM 403 and executed by the computing unit 401, may execute one or more steps in the task execution method described above. Alternatively, in other embodiments, the computing unit 401 may be used to perform the task execution method by any other suitable means (e.g., by means of firmware).

Various embodiments of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM) or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, an user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be included in the scope of protection of the present disclosure.

What is claimed is:

1. A task execution method, the method comprising:
executing, using at least one hardware device, an inference task based on a large model according to a sequence of input data units, so as to obtain a sequence of output data units for the sequence of input data units, first probability information for the sequence of input data units, and second probability information for the sequence of input data units, wherein the first probability information comprises at least one first probability value, the at least one first probability value corresponds one-to-one to at least one first data unit in the sequence of output data units, the second probability information comprises at least one second probability value, and the at least one second probability value corresponds one-to-one to at least one second data unit in a sequence of label data units of the sequence of input data units; and
determining a difficulty evaluation result for the sequence of input data units according to the first probability information and the second probability information.

2. The method according to claim 1, wherein the first probability information comprises a plurality of first probability values, and the second probability information comprises plurality of second probability values, and
wherein the determining a difficulty evaluation result for the sequence of input data units according to the first probability information and the second probability information comprises:
multiplying the plurality of first probability values to obtain a first product result as first fusion information;
multiplying the plurality of second probability values to obtain a second product result as second fusion information; and
determining the difficulty evaluation result for the sequence of input data units according to the first fusion information and the second fusion information.

3. The method according to claim 2, wherein the determining the difficulty evaluation result for the sequence of input data units according to the first fusion information and the second fusion information comprises:
dividing the second fusion information by the first fusion information to obtain a division operation result;
raising the division operation result to a power of a reciprocal of an evaluation parameter to obtain a root result, wherein the evaluation parameter is determined according to at least one of a first quantity or a second quantity, the first quantity being a number of first data units in the sequence of output data units, the second quantity being a number of second data units in the sequence of label data units of the sequence of input data units; and
subtracting the root result from a preset value to obtain the difficulty evaluation result.

4. The method according to claim 1, wherein the executing, using at least one hardware device, an inference task based on a large model according to a sequence of input data units comprises:
executing, using the at least one hardware device, a plurality of inference tasks based on the large model according to a plurality of sequences of input data units, so as to obtain a plurality of sequences of output data units respectively for the plurality of sequences of input data units, a plurality of first probability information respectively for the plurality of sequences of input data units, and a plurality of second probability information respectively for the plurality of sequences of input data units.

5. The method according to claim 4, further comprising:
determining at least one sequence of input data units corresponding one-to-one to at least one target evaluation result as at least one sequence of training data units, wherein the target evaluation result is a difficulty evaluation result being greater than or equal to a preset difficulty threshold among a plurality of difficulty evaluation results; and
executing, using the at least one hardware device, at least one first training task for the large model according to the at least one sequence of training data units, so as to reduce hardware resource overhead required for executing a plurality of second training tasks for the large model according to the plurality of sequences of input data units.

6. The method according to claim 5, wherein the first training task comprises a forward computation subtask and a backward computation subtask, and
the executing, using the at least one hardware device, at least one first training task for the large model according to the at least one sequence of training data units comprises:
executing, using the at least one hardware device, the forward computation subtask for the large model according to the sequence of training data units, so as to obtain a sequence of data units to be verified for training data; and
executing, using the at least one hardware device, the backward computation subtask for the large model according to a difference between the sequence of data units to be verified and a sequence of label data units of the sequence of training data units, so as to adjust a parameter of the large model.

7. The method according to claim 1, wherein the difficulty evaluation result indicates a difficulty of executing the inference task based on the large model according to the sequence of input data units.

8. The method according to claim 1, wherein the sequence of input data units is determined according to at least one of an input text, an input image, an input audio, or an input video, and the sequence of output data units is converted into at least one of an output text, an output image, an output audio, or an output video.

9. The method according to claim 8, wherein the sequence of input data units comprises a sequence of input tokens determined according to the input text, and the sequence of output data units is a sequence of output tokens, and
the executing, using at least one hardware device, an inference task based on a large model according to a sequence of input data units comprises:
tokenizing the input text to obtain the sequence of input tokens;
executing, using at least one hardware device, the inference task based on the large model according to the sequence of input tokens, so as to obtain the sequence of output tokens for the sequence of input tokens; and
obtaining the output text according to the sequence of output tokens.

10. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
execute, using at least one hardware device, an inference task based on a large model according to a sequence of input data units, so as to obtain a sequence of output data units for the sequence of input data units, first probability information for the sequence of input data units, and second probability information for the sequence of input data units, wherein the first probability information comprises at least one first probability value, the at least one first probability value corresponds one-to-one to at least one first data unit in the sequence of output data units, the second probability information comprises at least one second probability value, and the at least one second probability value corresponds one-to-one to at least one second data unit in a sequence of label data units of the sequence of input data units; and
determine a difficulty evaluation result for the sequence of input data units according to the first probability information and the second probability information.

11. The electronic device according to claim 10, wherein the first probability information comprises a plurality of first probability values, and the second probability information comprises plurality of second probability values, and
wherein the instructions are further configured to cause the at least one processor to at least:
multiply the plurality of first probability values to obtain a first product result as first fusion information;
multiply the plurality of second probability values to obtain a second product result as second fusion information; and
determine the difficulty evaluation result for the sequence of input data units according to the first fusion information and the second fusion information.

12. The electronic device according to claim 11, wherein the instructions are further configured to cause the at least one processor to at least:
divide the second fusion information by the first fusion information to obtain a division operation result;
raise the division operation result to a power of a reciprocal of an evaluation parameter to obtain a root result, wherein the evaluation parameter is determined according to at least one of a first quantity or a second quantity, the first quantity being a number of first data units in the sequence of output data units, the second quantity being a number of second data units in the sequence of label data units of the sequence of input data units; and
subtract the root result from a preset value to obtain the difficulty evaluation result.

13. The electronic device according to claim 10, wherein the instructions are further configured to cause the at least one processor to at least:
execute, using the at least one hardware device, a plurality of inference tasks based on the large model according to a plurality of sequences of input data units, so as to obtain a plurality of sequences of output data units respectively for the plurality of sequences of input data units, a plurality of first probability information respectively for the plurality of sequences of input data units, and a plurality of second probability information respectively for the plurality of sequences of input data units.

14. The electronic device according to claim 13, wherein the instructions are further configured to cause the at least one processor to at least:
determine at least one sequence of input data units corresponding one-to-one to at least one target evaluation result as at least one sequence of training data units, wherein the target evaluation result is a difficulty evaluation result being greater than or equal to a preset difficulty threshold among a plurality of difficulty evaluation results; and
execute, using the at least one hardware device, at least one first training task for the large model according to the at least one sequence of training data units, so as to reduce hardware resource overhead required for executing a plurality of second training tasks for the large model according to the plurality of sequences of input data units.

15. The electronic device according to claim 14, wherein the first training task comprises a forward computation subtask and a backward computation subtask, and
wherein the instructions are further configured to cause the at least one processor to at least:
execute, using the at least one hardware device, the forward computation subtask for the large model according to the sequence of training data units, so as to obtain a sequence of data units to be verified for training data; and
execute, using the at least one hardware device, the backward computation subtask for the large model according to a difference between the sequence of data units to be verified and a sequence of label data units of the sequence of training data units, so as to adjust a parameter of the large model.

16. The electronic device according to claim 10, wherein the difficulty evaluation result indicates a difficulty of executing the inference task based on the large model according to the sequence of input data units.

17. The electronic device according to claim 10, wherein the sequence of input data units is determined according to at least one of an input text, an input image, an input audio, or an input video, and the sequence of output data units is converted into at least one of an output text, an output image, an output audio, or an output video.

18. The electronic device according to claim 17, wherein the sequence of input data units comprises a sequence of input tokens determined according to the input text, and the sequence of output data units is a sequence of output tokens, and
wherein the instructions are further configured to cause the at least one processor to at least:
tokenize the input text to obtain the sequence of input tokens;
execute, using at least one hardware device, the inference task based on the large model according to the sequence of input tokens, so as to obtain the sequence of output tokens for the sequence of input tokens; and
obtain the output text according to the sequence of output tokens.

19. A non-transitory computer-readable storage medium having computer instructions therein, wherein the computer instructions are configured to cause a computer to at least:
execute, using at least one hardware device, an inference task based on a large model according to a sequence of input data units, so as to obtain a sequence of output data units for the sequence of input data units, first probability information for the sequence of input data units, and second probability information for the sequence of input data units, wherein the first probability information comprises at least one first probability value, the at least one first probability value corresponds one-to-one to at least one first data unit in the sequence of output data units, the second probability information comprises at least one second probability value, and the at least one second probability value corresponds one-to-one to at least one second data unit in a sequence of label data units of the sequence of input data units; and
determine a difficulty evaluation result for the sequence of input data units according to the first probability information and the second probability information.

20. The non-transitory computer-readable storage medium according to claim 19, wherein the first probability information comprises a plurality of first probability values, and the second probability information comprises plurality of second probability values, and
wherein the computer instructions are further configured to cause the computer to at least:
multiply the plurality of first probability values to obtain a first product result as first fusion information;
multiply the plurality of second probability values to obtain a second product result as second fusion information; and
determine the difficulty evaluation result for the sequence of input data units according to the first fusion information and the second fusion information.
